(19) United States
(12) Patent Application Publication
(10) Pub. No.: US 2014/0013349 A1
(43) Pub. Date: Jan. 9, 2014

(54) Content Insertion in Adaptive Streams

(71) Applicants: Keith Millar, Haywards Heath (GB); Trevor Smith, Twickenham (GB); Ian R. Shelton, Ringwood (GB)

(72) Inventors: Keith Millar, Haywards Heath (GB); Trevor Smith, Twickenham (GB); Ian R. Shelton, Ringwood (GB)

(73) Assignee: Cisco Technology Inc., San Jose, CA (US)

(21) Appl. No.: 14/001,366

(22) PCT Filed: Oct. 3, 2011
(86) PCT No.: PCT/IB11/54328

§ 371 Date: Aug. 23, 2013

(30) Foreign Application Priority Data
Feb. 6, 2011 (GB) 1109236.8

(51) Int. Cl. H04N 21/85

(52) U.S. Cl. CPC H04N 21/85
USPC 725/32

(57) ABSTRACT

A method including providing a first content item for consumption, the first content item having a content placement opportunity at which a second content item can be consumed, dividing the first content item into a plurality of chunks, the placement opportunity being temporally disposed after a first one of the chunks and/or before a second one of the chunks, after a first point where the first chunk is operative to finish being rendered and/or before a second point where the second chunk is operative to start being rendered, and encoding the chunks yielding a plurality of encoded chunks, wherein the encoding includes performing, for each one of the chunks of the first content item encoding the audio/video frames of the one chunk at a first audio/video quality, and repeating encoding of the audio/video frames of the one chunk at a second audio/video quality. Related apparatus and methods are also described.

### FIELD OF THE INVENTION

The present invention relates to content insertion in adaptive streams.

### BACKGROUND OF THE INVENTION

By way of introduction, with an increase in the quantity of video which is being delivered across the open Internet, a number of companies have developed technology that allows the client to choose the bitrate of the video to be delivered based upon the current network characteristics. For example, the client may initially request content at a low bitrate so as to start presenting something sooner. Then once the first few seconds of video have been retrieved the client requests the subsequent video at a higher bitrate so as to improve the quality of the video. If the quality of service of the network decreases, the client will start requesting lower bitrate video.

Adaptive bitrate steaming is typically achieved by splitting the audio/video stream into chunks, where a chunk represents a set of decodable frames. Chunks may be any suitable duration, but are typically between 3-10 seconds in duration.

The chunks are then referenced by the content's Manifest File, which is downloaded at the start of a content streaming session. The Manifest file typically defines all the chunks for each selectable bitrate.

In some implementations, the URLs for the chunks are computed in the client using a well defined algorithm.

Advertising within the current solutions appears to be supported in two different ways, dual decoder and Headend insertion.

In the dual decoder model the client pauses the main stream being rendered by one decoder and switches to start rendering another stream containing the advertisement(s) using another decoder. The dual decoder model typically requires sufficient memory and decoder resources in the device to perform two separate video decodes.

In Headend insertion, the Headend inserts advertisements real-time into the stream, resulting in potentially a unique stream per client.

The dual decoder model appears to be the more common solution, as it requires no conditioning of the stream and is completely client based. It also does not have the scalability issues of the Headend insertion model. However, the dual decoder model requires the client player implementation to support local content insertion/substitution.

The following references are also believed to represent the state of the art:

US Published Patent Application 2007/162568 of Gupta, et al.;

US Published Patent Application 2010/235472 of Sood, et al.;

PCT Published Patent Application WO 2010/131128 of NDS Limited;

PCT Published Patent Application WO 2010/117316 of Telefonaktiebolaget L M Ericsson;

PCT Published Patent Application WO 2010/134984 of Creative Ad Technology Proprietary limited; and

American National Standard ANSI/SCTE 138 2009.

### SUMMARY OF THE INVENTION

The present invention, in certain embodiments thereof, seeks to provide an improved content insertion system/method for adaptive streams.

The present invention, in embodiments thereof, provides a solution for performing targeted advertising or other content replacement within adaptive streaming environments while minimizing server and client resources. The solution is particularly suitable for a client device with limited memory and/or a single audio/video decoder. In addition the solution is particularly useful for enabling client based targeted advertising within existing deployed media players without modification (in most cases). The solution typically makes use of the Manifest File delivered at the start of the streaming session to deliver a complete set of chunks that should be played including the chunks forming the primary content and the chunks including the targeted advertisement(s) that should be played. Typically the chunks are provided such that the boundary/boundaries between the advertisement(s) and the primary content are aligned with chunk boundaries so that none of the chunks include both a part of the primary content and part of the targeted advertisement(s). The client media player sees the set of chunks (including the primary content and the targeted advertisement(s)), and will typically be unaware that some of the content chunks are targeted advertisement(s), so that the primary content and the targeted advertisement(s) may be played by the media player using a single decoder in a seamless fashion.

There is thus provided in accordance with an embodiment of the present invention, a system including physical computing machinery including a chunking processor to provide a first content item for consumption by a user, the first content item including a plurality of audio/video frames having a temporal rendering order, the first content item having a content placement opportunity at which a second content item can be consumed by the user at the start of, or in the middle of, or at the end of, the consumption of the first content item, and divide the first content item into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and/or before a second one of the chunks, the placement opportunity being temporally disposed after a first point where the first chunk is operative to finish being rendered and/or before a second point where the second chunk is operative to start being rendered, and an audio/video codec to encode the chunks yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item encoding the audio/video frames of the one chunk at a first audio/video quality yielding a first encoded chunk including the encoded audio/video frames encoded at the first audio/video quality, and repeating the encoding of the audio/video frames of the one chunk at a second audio/video quality yielding a second encoded chunk including the encoded audio/video frames encoded at the second audio/video quality.

Further in accordance with an embodiment of the present invention, the chunking processor is operative to divide the second content item into a plurality of chunks, each of the chunks of the second content item including a plurality of audio/video frames, and the audio/video codec is operative to encode the chunks of the second content item yielding a plurality of encoded chunks of the second content item, each of the encoded chunks of the second content item including a plurality of encoded audio/video frames, each one of the chunks of the second content item being encoded such that decoding an encoded version of the one chunk of the second content item does not require audio/video frame data from any other of the encoded chunks.

Still further in accordance with an embodiment of the present invention, the audio/video codec is operative to encode the chunks of the second content item such that, for each one of the chunks of the second content item, the audio/video codec is operative to encode the audio/video frames of the one chunk at a third audio/video quality yielding a third encoded chunk including a plurality of encoded audio/video frames encoded at the third audio/video quality, and repeat the encoding of the audio/video frames of the one chunk at a fourth audio/video quality yielding a fourth encoded chunk including a plurality of encoded audio/video frames encoded at the fourth audio/video quality.

Additionally in accordance with an embodiment of the present invention, the physical computing machinery includes a file processor to create a manifest file referencing the encoded chunks of the first content item including referencing the first encoded chunk and the second encoded chunk for each of the chunks of the first content item.

Moreover in accordance with an embodiment of the present invention, the file processor is operative to include, in the manifest file, a reference referencing the content placement opportunity.

Further in accordance with an embodiment of the present invention, the reference to the content placement opportunity includes a link to a content decision system which decides which content item should be selected from a selection of content items for rendering as the second content item at the content placement opportunity.

Still further in accordance with an embodiment of the present invention, the file processor is operative to include, in the manifest file, metadata for use in deciding which content item should be selected from the selection of content items for rendering as the second content item at the content placement opportunity.

Additionally in accordance with an embodiment of the present invention, the physical computing machinery includes a content selection processor to decide which content item should be selected from a selection of content items for rendering as the second content item at the content placement opportunity.

Moreover in accordance with an embodiment of the present invention, the file processor is operative to remove, from the manifest file, the reference referencing the placement opportunity.

Further in accordance with an embodiment of the present invention, the file processor is operative to include, in the manifest file, a plurality of references referencing the second content item.

Still further in accordance with an embodiment of the present invention, each one of the encoded chunks of the first content item includes a random access point, the audio/video codec being operative to encode the one encoded chunk of the first content item such that a first one of the encoded audio/video frames of the one encoded chunk of the first content item to be decoded is at the random access point.

Additionally in accordance with an embodiment of the present invention, the audio/video codec is operative to encode the first content item into a plurality of groups of pictures so that each of the encoded chunks of the first content item includes some of the groups of pictures.

Moreover in accordance with an embodiment of the present invention, the chunking processor is operative to divide the first content item such that the chunks of the first content item have different durations.

Further in accordance with an embodiment of the present invention, the chunking processor is operative to determine the duration of some of the chunks prior to the content placement opportunity so that the first chunk, temporally disposed immediately prior to the content placement opportunity, has a duration greater than a predetermined duration.

Still further in accordance with an embodiment of the present invention, the second content item can be consumed by the user in the middle of the consumption of the first content item, and the placement opportunity is temporally disposed after the first one of the chunks and before the second one of the chunks, the placement opportunity being temporally disposed after a first point where the first chunk is operative to finish being rendered and before a second point where the second chunk is operative to start being rendered.

Additionally in accordance with an embodiment of the present invention, the physical computing machinery includes a content selection processor to decide that no content item should be selected for rendering as the second content item at the content placement opportunity.

There is also provided in accordance with still another embodiment of the present invention, a system including physical computing machinery including a receiver to receive a manifest file referencing a first content item, the first content item being for consumption by a user, the first content item including a plurality of audio/video frames having a temporal rendering order, the first content item having a content placement opportunity at which a second content item can be consumed by the user at the start of, or in the middle of, or at the end of, the consumption of the first content item, the first content item being divided into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and/or before a second one of the chunks, the placement opportunity being temporally disposed after a first point where the first chunk is operative to finish being rendered and/or before a second point where the second chunk is operative to start being rendered, the chunks being encoded yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item encoding the audio/video frames of the one chunk at a first audio/video quality yielding a first encoded chunk including the encoded audio/video frames encoded at the first audio/video quality, and repeating the encoding of the audio/video frames of the one chunk at a second audio/video quality yielding a second encoded chunk including the encoded audio/video frames encoded at the second audio/video quality, wherein the manifest file template references the encoded chunks of the first content item including referencing the first encoded chunk and the second encoded chunk for each of the chunks of the first content item, and the manifest file template includes a reference referencing the content placement opportunity, and a content selection processor to decide which content item, if any, should be selected from a selection of content items for rendering as the second content item at the content placement opportunity.

Moreover in accordance with an embodiment of the present invention, the manifest file includes metadata for use in deciding which content item should be selected from the selection of content items for rendering as the second content item at the content placement opportunity.

Further in accordance with an embodiment of the present invention, the physical computing machinery includes a file processor to remove, from the manifest file, the reference referencing the placement opportunity, and include, in the manifest file, a plurality of references referencing the second content item.

Still further in accordance with an embodiment of the present invention, the physical computing machinery includes a player to render the second content item at the content placement opportunity.

Additionally in accordance with an embodiment of the present invention, the first content item is divided into the chunks such that the chunks of the first content item have different durations.

Moreover in accordance with an embodiment of the present invention, the duration of some of the chunks prior to the content placement opportunity is determined so that the first chunk, temporally disposed immediately prior to the content placement opportunity, has a duration greater than a predetermined duration.

Further in accordance with an embodiment of the present invention, the second content item is divided into a plurality of chunks, each of the chunks of the second content item including a plurality of audio/video frames, the chunks of the second content item being encoded to yield a plurality of encoded chunks of the second content item, each of the encoded chunks of the second content item including a plurality of encoded audio/video frames, each one of the chunks of the second content item being encoded such that decoding an encoded version of the one chunk of the second content item does not require audio/video frame data from any other of the encoded chunks.

Still further in accordance with an embodiment of the present invention, the second content item can be consumed by the user in the middle of the consumption of the first content item, and the placement opportunity is temporally disposed after the first one of the chunks and before the second one of the chunks, the placement opportunity being temporally disposed after a first point where the first chunk is operative to finish being rendered and before a second point where the second chunk is operative to start being rendered.

There is also provided in accordance with still another embodiment of the present invention, a method including providing a first content item for consumption by a user, the first content item including a plurality of audio/video frames having a temporal rendering order, the first content item having a content placement opportunity at which a second content item can be consumed by the user at the start of, or in the middle of, or at the end of, the consumption of the first content item, dividing the first content item into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and/or before a second one of the chunks, the placement opportunity being temporally disposed after a first point where the first chunk is operative to finish being rendered and/or before a second point where the second chunk is operative to start being rendered, and encoding the chunks yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item encoding the audio/video frames of the one chunk at a first audio/video quality yielding a first encoded chunk including the encoded audio/video frames encoded at the first audio/video quality, and repeating the encoding of the audio/video frames of the one chunk at a second audio/video quality yielding a second encoded chunk including the encoded audio/video frames encoded at the second audio/video quality.

There is also provided in accordance with still another embodiment of the present invention, a method including receiving a manifest file referencing a first content item, the first content item being for consumption by a user, the first content item including a plurality of audio/video frames having a temporal rendering order, the first content item having a content placement opportunity at which a second content item can be consumed by the user at the start of, or in the middle of, or at the end of, the consumption of the first content item, the first content item being divided into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and/or before a second one of the chunks, the placement opportunity being temporally disposed after a first point where the first chunk is operative to finish being rendered and/or before a second point where the second chunk is operative to start being rendered, the chunks being encoded yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item encoding the audio/video frames of the one chunk at a first audio/video quality yielding a first encoded chunk including the encoded audio/video frames encoded at the first audio/video quality, and repeating the encoding of the audio/video frames of the one chunk at a second audio/video quality yielding a second encoded chunk including the encoded audio/video frames encoded at the second audio/video quality, wherein the manifest file template references the encoded chunks of the first content item including referencing the first encoded chunk and the second encoded chunk for each of the chunks of the first content item, and the manifest file template includes a reference referencing the content placement opportunity, and deciding which content item, if any, should be selected from a selection of content items for rendering as the second content item at the content placement opportunity.

### BRIEF DESCRIPTION OF THE DRAWINGS

The present invention will be understood and appreciated more fully from the following detailed description, taken in conjunction with the drawings in which:

FIG. 1 is a partly pictorial, partly block diagram view of adaptive stream encoding;

FIG. 2 is a partly pictorial/partly block diagram view of a content provider constructed and operative in accordance with an embodiment of the present invention;

FIG. 3 is a partly pictorial/partly block diagram view of adaptive stream encoding performed by the content provider of FIG. 2;

FIG. 4 is a partly pictorial/partly block diagram view of a manifest file template created by the content provider of FIG. 2;

FIG. 5 is a partly pictorial/partly block diagram view of adaptive stream encoding including secondary content performed by the content provider of FIG. 2; and

FIG. 6 is a partly pictorial/partly block diagram view of a tailored manifest file amended by the content provider of FIG. 2.

### DETAILED DESCRIPTION OF AN EMBODIMENT

The term “encoded” is used throughout the present specification and claims, in all of its grammatical forms, to refer to any type of data stream encoding including, for example and without limiting the scope of the definition, well known types of encoding such as, but not limited to, MPEG-2 encoding, H.264 encoding, VC-1 encoding, and synthetic encodings such as Scalable Vector Graphics (SVG) and LASER (ISO/IEC 14496-20), and so forth. It is appreciated that an encoded data stream generally requires more processing and typically more time to read than a data stream which is not encoded. Any recipient of encoded data, whether or not the recipient of the encoded data is the intended recipient, is, at least in potential, able to read encoded data without requiring cryptanalysis. It is appreciated that encoding may be performed in several stages and may include a number of different processes, including, but not necessarily limited to: compressing the data; transforming the data into other forms; and making the data more robust (for instance replicating the data or using error correction mechanisms).

The term “compressed” is used throughout the present specification and claims, in all of its grammatical forms, to refer to any type of data stream compression. Compression is typically a part of encoding and may include image compression and motion compensation. Typically, compression of data reduces the number of bits comprising the data. In that compression is a subset of encoding, the terms “encoded” and “compressed”, in all of their grammatical forms, are often used interchangeably throughout the present specification and claims.

Similarly, the terms “decoded” and “decompressed” are used throughout the present specification and claims, in all their grammatical forms, to refer to the reverse of “encoded” and “compressed” in all their grammatical forms.

The terms “scrambled” and “encrypted”, in all of their grammatical forms, are used interchangeably throughout the present specification and claims to refer to any appropriate scrambling and/or encryption methods for scrambling and/or encrypting a data stream, and/or any other appropriate method for intending to make a data stream unintelligible except to an intended recipient(s) thereof. Well known types of scrambling or encrypting include, but are not limited to DES, 3DES, and AES. Similarly, the terms “descrambled” and “decrypted” are used throughout the present specification and claims, in all their grammatical forms, to refer to the reverse of “scrambled” and “encrypted” in all their grammatical forms.

Pursuant to the above definitions, the terms “encoded”; “compressed”; and the terms “scrambled” and “encrypted” are used to refer to different and exclusive types of processing. Thus, a particular data stream may be, for example:
encoded, but neither scrambled nor encrypted;
compressed, but neither scrambled nor encrypted;
scrambled or encrypted, but not encoded;
scrambled or encrypted, but not compressed;
encoded, and scrambled or encrypted; or
compressed, and scrambled or encrypted.

Likewise, the terms “decoded” and “decompressed” on the one hand, and the terms “descrambled” and “decrypted” on the other hand, are used to refer to different and exclusive types of processing.

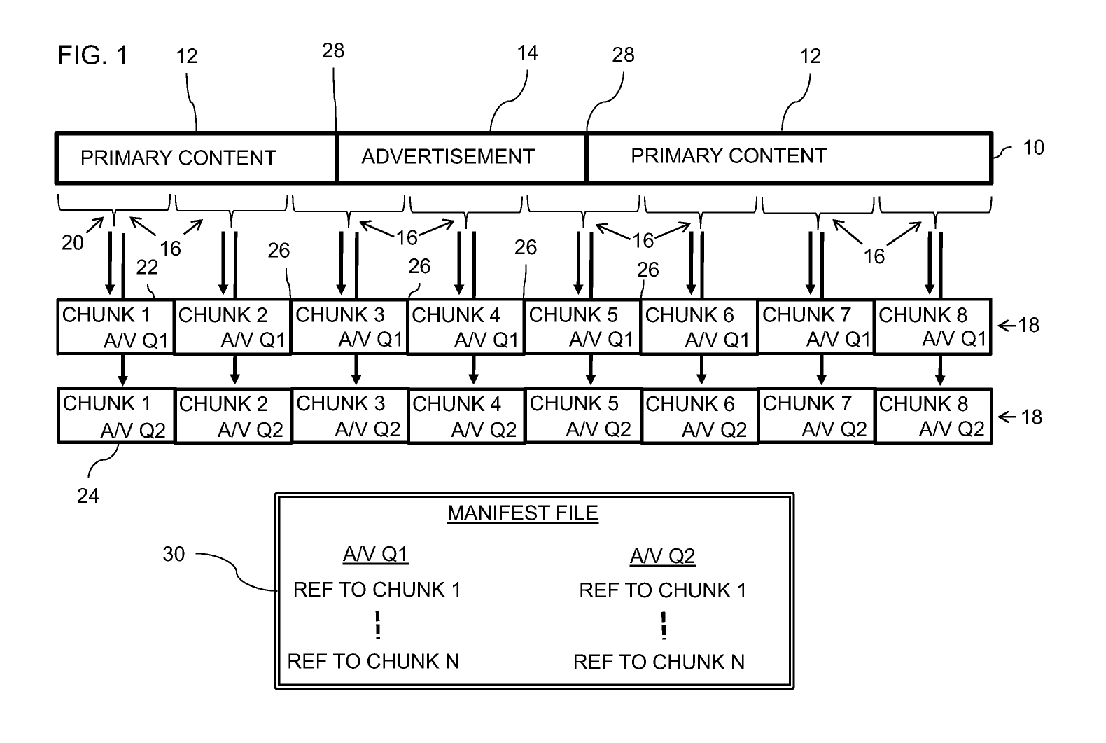

Reference is now made to FIG. 1, which is a partly pictorial, partly block diagram view of adaptive stream encoding.

FIG. 1 shows a content stream 10 which includes a primary content item 12 and an advertisement 14 disposed in the middle of the primary content item 12. In order to prepare the content stream 10 for use by client devices (not shown), a content server (not shown) first divides the content stream 10 into a plurality of chunks 16. Each of the chunks 16 is typically encoded at a plurality of video qualities yielding a plurality of encoded chunks 18 each encoded at a different audio/video quality. So for example, a chunk 20 is first encoded at a first audio/video quality (Q1) yielding an encoded chunk 22 (CHUNK 1) and then at a second audio/video quality (Q2) yielding an encoded chunk 24 (CHUNK 2). FIG. 1 shows two encoded chunks 18 for each non-encoded chunk 16 of the content stream 10. The client devices are then able to decide which audio/video quality encoded chunks 18 to select from a manifest file 30 for retrieval and decoding depending upon various factors including bandwidth and processing availability.

If the server wants to replace the advertisement 14 with another advertisement, then the server needs to prepare an additional stream for the replacement advertisement and instruct the client device to retrieve the audio/video data for the replacement advertisement and then play the replacement advertisement instead of the advertisement 14. However, as the boundaries 26 between the encoded chunks 18 (and therefore GOP (group of picture) boundaries) are not aligned with the boundaries 28 between the primary content item 12 and the advertisement 14, the client will need to pause decoding of the encoded chunks 18 while decoding the replacement advertisement. The aforementioned process will typically require the client to have two decoders in order to perform a seamless splice between the primary content item 12 and the replacement advertisement and back to the primary content item 12 again. This problem will also typically occur if the client is performing local advertisement replacement.

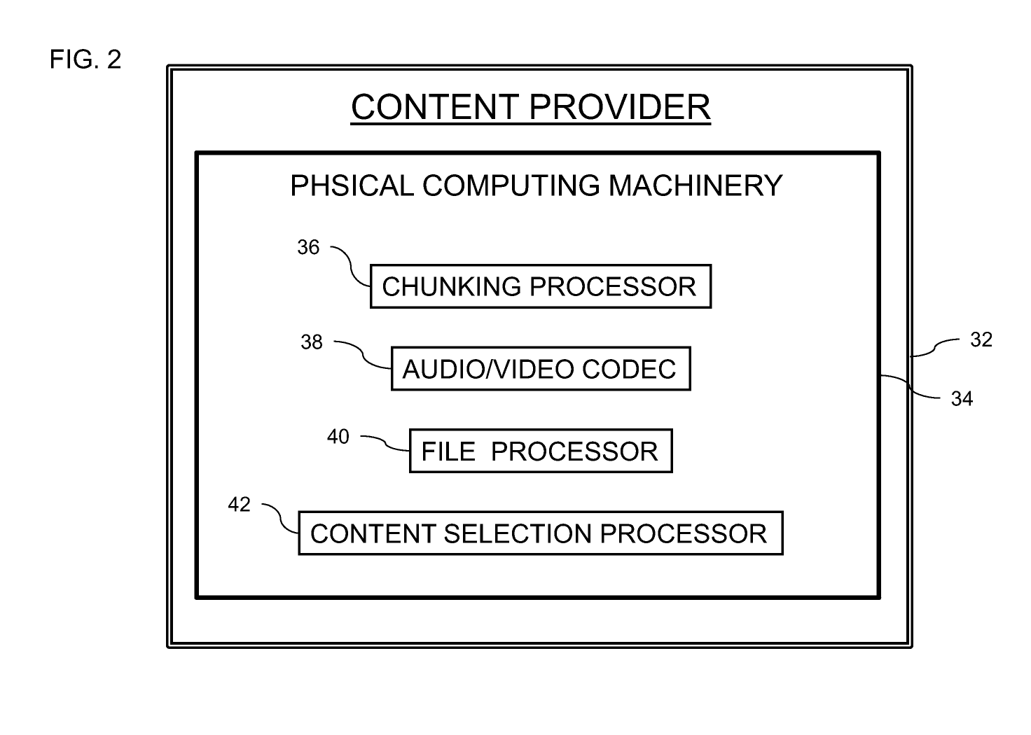

Reference is now made to FIG. 2, which is a partly pictorial/partly block diagram view of a content provider 32 constructed and operative in accordance with an embodiment of the present invention.

In order to solve the problem described above with reference to FIG. 1, the content provider 32 is typically operative to control encoding of content such that chunk boundaries (and GOP boundaries, where GOPs are used) are aligned with content placement opportunities.

The term “content provider”, as used in the specification and claims, is defined to include any suitable preparer and/or encoder and/or distributor of content, for example, but not limited to, a Headend.

The content provider 32 typically includes physical computing machinery 34 including a chunking processor 36, a audio/video codec 38, a file processor 40 and a content selection processor 42.

In practice, some or all of the functions performed by the content provider 32 may be combined in a single physical component or, alternatively, implemented using multiple physical components. These physical components may comprise hard-wired or programmable devices, or a combination of the two. In some embodiments, at least some of the functions of the content provider 32 may be carried out by a programmable processor under the control of suitable software.

The content provider 32 is now described in more detail below.

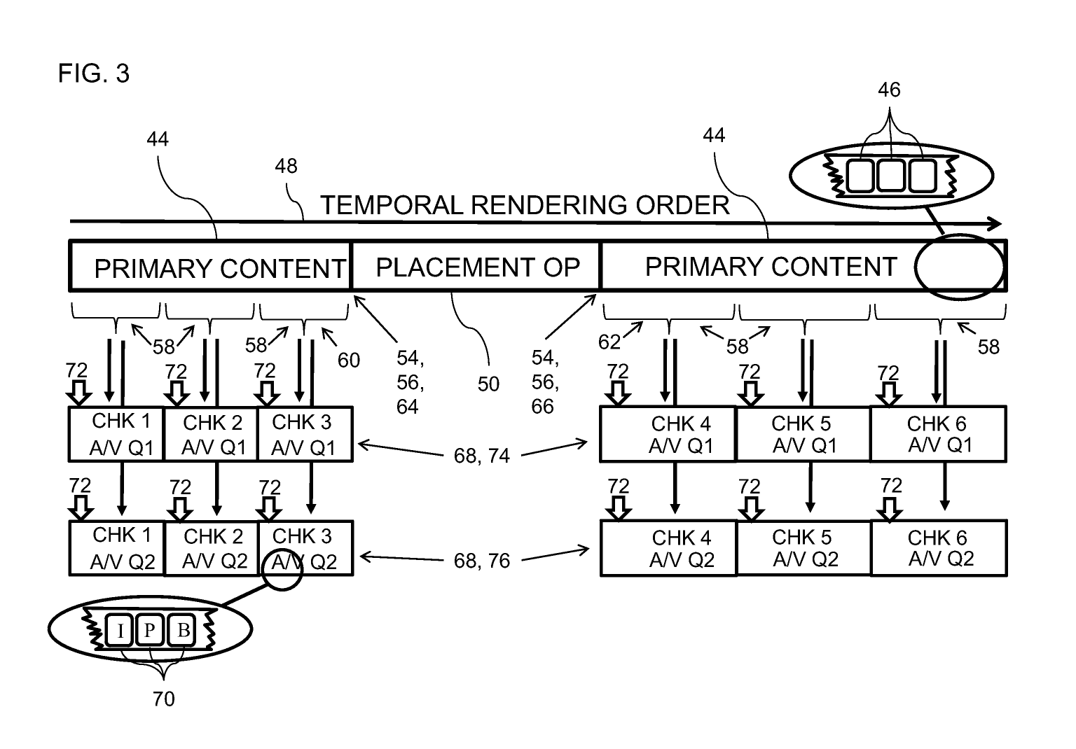

Reference is now made to FIG. 3, which is a partly pictorial/partly block diagram view of adaptive stream encoding performed by the content provider 32 of FIG. 2. Reference is also made to FIG. 2.

The chunking processor 36 is operative to receive a primary content item 44 for consumption by a user (not shown). Primary content item 44 typically includes a plurality of audio/video frames 46 having a temporal rendering order (indicated by arrow 48). The temporal rendering order 48 may be indicated by presentation time stamps, by way of example only. The primary content item 44 has a content placement opportunity 50 at which a secondary content item (for example an advertisement, a promotional audio/video, regional content, or alternative endings to content) can be consumed by the user at the start, or in the middle or at the end, of the consumption of the primary content item 44. The primary content item 44 may include one or more of the content placement opportunity 50 at the start and/or middle and/or end of the primary content item 44.

The primary content item 44 may or may not include an existing embedded advertisement or other secondary content item (not shown) at the content placement opportunity 50. Where the primary content item 44 does include an embedded advertisement (or other secondary content item) in the middle of the primary content item 44, the content provider 32 is typically operative to provide for content/advertisement substitution at the content placement opportunity 50 which includes two boundaries 56. The substituted content does not necessarily need to be the same duration as the original embedded content. Where the primary content item 44 does not include an embedded advertisement (or other secondary content item), the content provider 32 is typically operative to provide for content/advertisement insertion at the content placement opportunity 50 which includes one boundary 56. Where the content placement opportunity 50 is at the start or end of the primary content item 44, the content placement opportunity 50 typically includes one boundary 56.

The term “rendering”, as used in the specification and claims, is defined to include displaying and audio outputting.

The term “audio/video”, as used in the specification and claims, is defined to include audio and video, audio without video and video without audio.

The primary content item 44 needs to be chunked so that chunk boundaries 54 align with the boundary 56 (or boundaries 56) of the content placement opportunity 50. The chunking processor 36 is operative to divide the primary content item 44 into a plurality of chunks 58. Each chunk 58 includes some of the audio/video frames 46 wherein the audio/video frames 46 of that chunk 58 are for rendering consecutively in accordance with the temporal rendering order 48. When the content placement opportunity 50 is in the middle of the primary content item 44, the content placement opportunity 50 is temporally disposed between one of the chunks 58 (a chunk 60) and another one of the chunks 58 (a chunk 62). In other words, the content placement opportunity 50 is temporally disposed after a point 64 where the chunk 60 is operative to finish being rendered and before a point 66 where the chunk 62 is operative to start being rendered.

When the content placement opportunity 50 is at the start/end of the primary content item 44, the content placement opportunity 50 is temporally disposed before/after one of the chunks 58, respectively. In other words, when the content placement opportunity 50 is at the start/end of the primary content item 44, the content placement opportunity 50 is temporally disposed before/after a point where that chunk is operative to start/finish being rendered, respectively.

When the content placement opportunity 50 is in the middle of the primary content item, the duration of the chunk 60 may need to be shorter than the proceeding chunks 58 in order for the end of the chunk 60 to coincide with the beginning of the content placement opportunity 50. However, if the chunk 60 is too short, downloading the chunk 60 may result in an inefficient download implementation. Even if the duration of the chunk 60 is increased and the duration of a few of the chunks 58 prior to chunk 60 are reduced, the short duration of these adjusted chunks 58 may still result in an inefficient download implementation. Therefore, the chunking processor 36 is typically operative to vary the duration of as many of the chunks 58 as necessary in the run up to the content placement opportunity 50 to reduce or eliminate any download inefficiencies due to chunks 58 which are too short in duration.

It should be noted that chunk duration is not the same as chunk size. Chunks of the same duration may have different sizes and commonly do, due to variations introduced during encoding. However, duration is related to the rendering duration of the chunks, for example, but not limited to, how long it takes to render the chunk at real-time speed.

Therefore, the chunking processor 36 is typically operative to divide the primary content item 44 such that the chunks 58 of the primary content item 44 have different durations. Additionally, the chunking processor 36 is operative to determine the duration of some of the chunks 58 prior (with respect to the temporal rendering order 48) to the content placement opportunity 50 so that the chunk 60, temporally disposed immediately prior to the content placement opportunity 50, has a duration greater than a predetermined (below minimal) duration. Similarly, the chunking processor 36 is typically operative to determine the duration of all the chunks 58 to be greater than the predetermined duration. In FIG. 3, the chunks 58 prior to the content placement opportunity 50 have the same duration which is shorter than the duration of the chunks 58 after the content placement opportunity 50.

Encoding of the chunks 58 will now be described.

The audio/video codec 38 is typically operative to encode the chunks 58 yielding a plurality of encoded chunks 68. Each encoded chunk 68 typically includes a plurality of encoded audio/video frames 70. The encoded audio/video frames 70 of each encoded chunk 68 are temporally ordered for rendering in accordance with the temporal rendering order 48.

Each chunk 58 is typically encoded multiple times at different audio/video qualities as will now be described.

The encoding generally includes: (i) encoding the audio/video frames 46 of one of the chunks 58 at a first audio/video quality (A/V Q1) yielding an encoded chunk 74 including the encoded audio/video frames 70 encoded at the first audio/video quality (A/V Q1); and (ii) repeating the encoding of the audio/video frames 46 of that same chunk 58 at a second audio/video quality (A/V Q2) yielding an encoded chunk 76 including the encoded audio/video frames 70 encoded at the second audio/video quality (A/V Q2). The above encoding step is typically repeated for the same chunk 58 with as many audio/video qualities as required. The above multiple encoding is performed for each of the chunks 58 of the primary content item 44 so there are multiple sets of encoded chunks 68, each set being encoded at a different audio/video quality.

The encoding is performed so that each chunk 58 is encoded such that decoding an encoded version of that chunk 58 does not require audio/video frame data from any other encoded chunk 68. In other words, each encoded chunk 68 includes an independently decodable set of audio/video data. Each encoded chunk 68 typically includes other data, for example, but not limited to, entitlement control messages (ECMs) and subtitles.

So in general, the audio/video codec 38 is typically operative such that: each encoded chunk 68 of the primary content item 44 includes a random access point 72; and the first encoded audio/video frame 70 (of each encoded chunk 68 of the primary content item 44) to be decoded is at the random access point. It should be noted that each encoded chunk 68 may include more than one random access point.

The audio/video codec 38 is typically operative to encode the primary content item 44 into a plurality of groups of pictures (not shown), Each encoded chunk 68 of the primary content item 44 typically includes some of the groups of pictures. However, it should be noted that a chunk could include a single GOP. The first and last GOP in each encoded chunk 68 is a closed GOP.

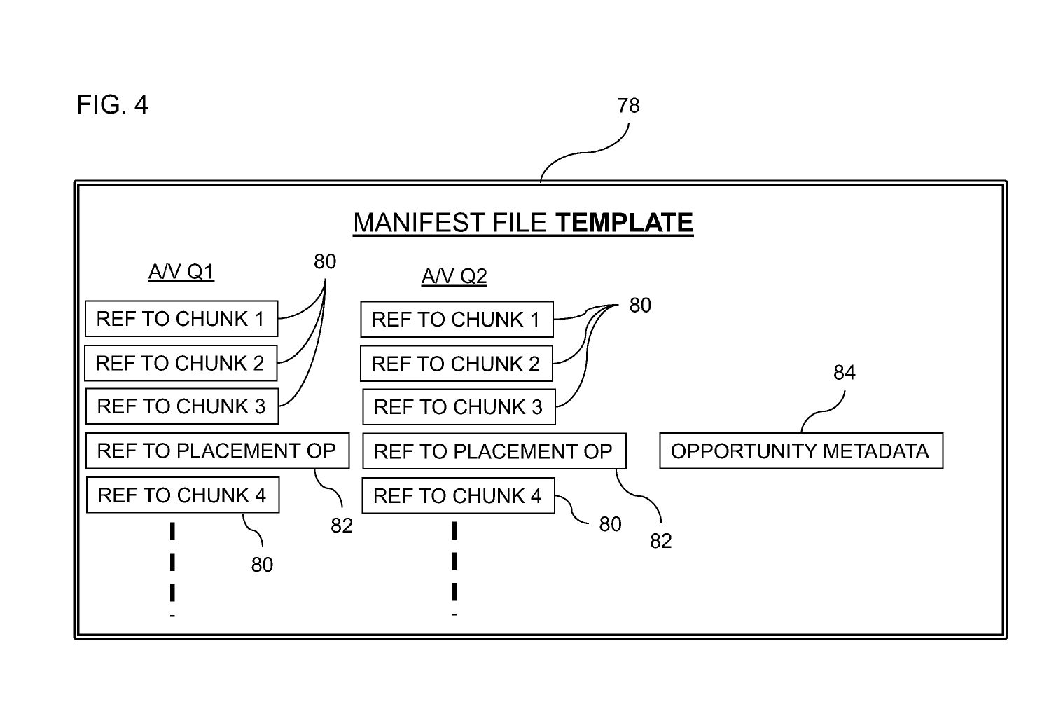

Reference is now made to FIG. 4, which is a partly pictorial/partly block diagram view of a manifest file template 78 created by the content provider 32 of FIG. 2.

Once the chunking has been performed the manifest file template 78 is typically created including references 80 to the encoded chunks 68 (FIG. 3) of the primary content item 44 (FIG. 3) as well as reference(s) 82 to the position of the content placement opportunity 50 (FIG. 3) among the encoded chunks 68 (FIG. 3).

Therefore, the file processor 40 (FIG. 2) is typically operative to create the manifest file template 78 with references 80 referencing the encoded chunks 68 (FIG. 3) of the primary content item 44 (FIG. 3) (including the encoded chunk 74 (FIG. 3) and the encoded chunk 76 (FIG. 3) for each chunk 58 (FIG. 3) of the primary content item 44 (FIG. 3)). Additionally, the file processor 40 (FIG. 2) is generally operative to include, in the manifest file template 78, the reference 82 referencing the position of the content placement opportunity 50 (FIG. 3) and metadata 84 for use in deciding which content item should be selected from a selection of content items for rendering at the content placement opportunity 50 (FIG. 3). The manifest file template 78 is typically stored, for example, but not limited to, caching the manifest file template 78 on a WEB server.

The manifest file template 78 is a template which can be amended when an appropriate content item is selected for rendering at the content placement opportunity 50 (FIG. 3).

It should be noted that instead of using a manifest file, the rendering clients could use an algorithm to determine the information needed to retrieve the encoded chunks 68 (FIG. 3). Employing this alternative method typically requires providing sufficient data to the rendering client, for example, but not limited to, the number of chunks and average chunk duration which may for example be used to estimated the required chunk when performing random jumps in the content.

In accordance with an alternative embodiment of the present invention, the reference 82 or metadata 84 may include a link to a content decision system (not shown) which decides which content item should be selected from a selection of content items for rendering as the secondary content item at the content placement opportunity 50.

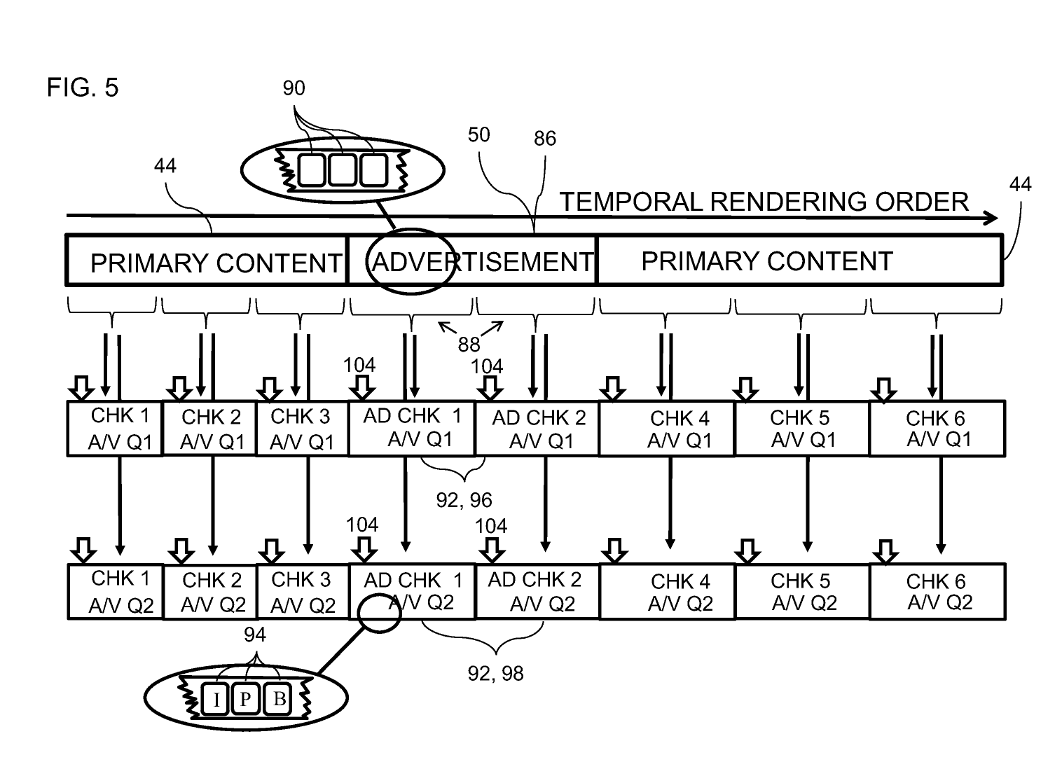

Reference is now made to FIG. 5, which is a partly pictorial/partly block diagram view of adaptive stream encoding including a secondary content item 86 performed by the content provider 32 of FIG. 2. The secondary content item 86 may include any suitable content item for example, but not limited to, an advertisement, a promotional audio/video, regional content, or alternative endings to content.

The content selection processor 42 (FIG. 2) is typically operative to decide which content item, if any, should be selected from a selection of content items (not shown), for a particular viewer/listener, for rendering as the secondary content item 86 at the content placement opportunity 50 based on various factors, for example, but not limited to, the profile of the viewer/listener who will consume the secondary content item 86, the genre of the primary content item 44 (FIG. 3) and the metadata 84 associated with the content placement opportunity 50.

It should be noted that the content selection processor 42 may decide that no content item should be selected for rendering as the secondary content item 86 at the content placement opportunity 50.

The secondary content item 86 is chunked and encoded in substantially the same way as the primary content item 44 as will now be explained in more detail below.

The chunking processor 36 (FIG. 2) is operative to divide the secondary content item 86 into a plurality of chunks 88. Each chunk 88 of the secondary content item 86 includes a plurality of audio/video frames 90.

The audio/video codec 38 (FIG. 2) is typically operative to encode the chunks 88 of the secondary content item 86 yielding a plurality of encoded chunks 92 of the secondary content item 86. Each encoded chunk 92 of the secondary content item 86 includes a plurality of encoded audio/video frames 94.

Each chunk 88 is encoded multiple times at different audio/video qualities as will now be described.

The encoding includes: (i) encoding the audio/video frames 90 of one of the chunks 88 at a first audio/video quality (A/V Q1) yielding an encoded chunk 96 including the encoded audio/video frames 94 encoded at the first audio/video quality (A/V Q1); and (ii) repeating the encoding of the audio/video frames 90 of that same chunk 88 at a second audio/video quality (A/V Q2) yielding an encoded chunk 98 including the encoded audio/video frames 94 encoded at the second audio/video quality (A/V Q2). The above encoding step is typically repeated for the same chunk 88 with as many audio/video qualities as required. The above multiple encoding is performed for each chunk 88 of the secondary content item 86 so there are multiple sets of encoded chunks 92, each set being encoded at a different audio/video quality.

Each chunk 88 of the secondary content item 86 is encoded such that decoding an encoded version of that chunk 88 of the secondary content item 86 does not require audio/video frame data from any other of the encoded chunks 92. Therefore, there exists a random access point 104 at least at the beginning of every encoded chunk 92. When the encoding results in GOPs, a closed GOP is typically disposed at the beginning and end of each encoded chunk 92.

Instead of having the chunks 88 encoded at different audio/video qualities, the chunks 88 may be encoded at a single audio/video quality so that there is only a single set of encoded chunks 92 (i.e. non-adaptive streaming) for the secondary content item 86.

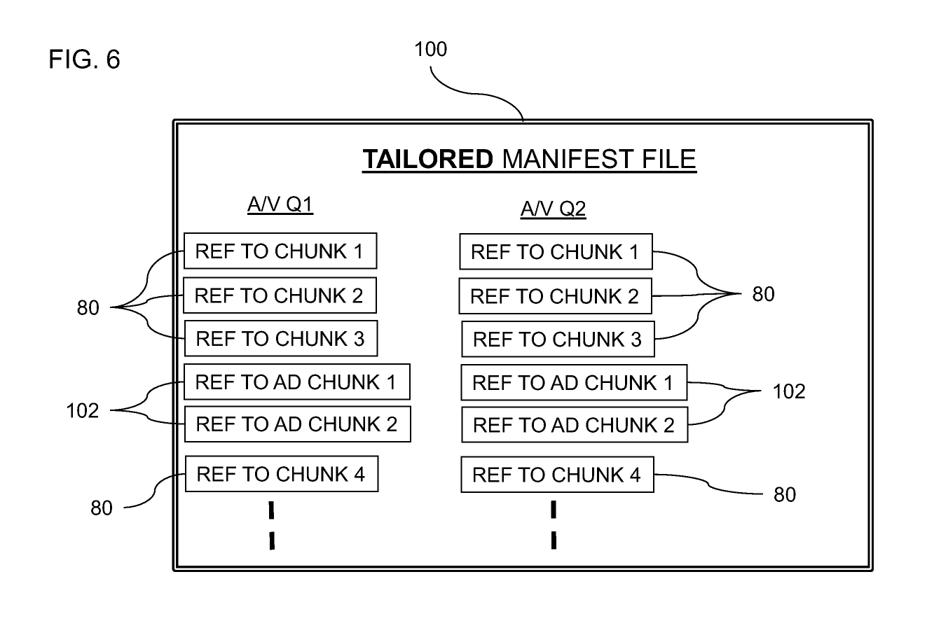

Reference is now made to FIG. 6, which is a partly pictorial/partly block diagram view of a tailored manifest file 100 amended by the content provider 32 of FIG. 2.

The file processor 40 (FIG. 2) is typically operative to modify the manifest file template 78 (FIG. 4) for the particular viewer/listener by including in the manifest file template 78 (FIG. 4), a plurality of references 102 to the encoded chunks 92 (FIG. 5) of the secondary content item 86 (FIG. 5), selected for the particular viewer/listener, thereby yielding the tailored manifest file 100 tailored for the particular viewer/listener.

During the tailoring process, the file processor 40 (FIG. 2) is also operative to remove, from the manifest file template 78 (FIG. 4), the reference 82 (FIG. 4) referencing the content placement opportunity 50 (FIG. 3) and the metadata 84 (FIG. 4) of the content placement opportunity 50 (FIG. 3).

The tailored manifest file 100 is now tailored for the particular viewer/listener including the references 80 to the encoded chunks 68 (FIG. 3) of the primary content item 44 (FIG. 3) and the references 102 to the encoded chunks 92 (FIG. 5) of the selected secondary content item 86 (FIG. 5).

The tailored manifest file 100 is then returned to the client rendering device of the particular viewer/listener.

The client rendering device of the viewer/listener can then start retrieval of the encoded chunks 68 (FIG. 3) of the primary content item 44 (FIG. 3) and the encoded chunks 92 (FIG. 5) of the selected secondary content item 86 (FIG. 5) and seamlessly splice from the primary content item 44 to the secondary content item 86 and back again using a single decoder, if necessary.

It should be noted that the selection of the secondary content item 86 and the tailoring of the manifest file template 78 to yield the tailored manifest file 100 may take place in the client rendering device or in any suitable client for example, but not limited to, an intermediary such as an Internet Service Provider, which includes a receiver to receive the manifest file template 78, a content selection processor to select the secondary content item 86 and a file processor to tailor the manifest file template 78 (as described above) for use by the client rendering device.

It should be noted that when the selection of the secondary content item 86 takes place in the client rendering device, the client rendering device receives the manifest file template 78 instead of the tailored manifest file 100. In such a case, the client rendering device is operative to select and render the secondary content item 86 at the content placement opportunity 50 signaled in the received manifest file template 78. If the secondary content item 86 is stored locally in the client rendering device, then the secondary content item 86 is rendered from local storage. If the secondary content item 86 is not stored locally, the client rendering device typically requests the location of the chunks of the secondary content item 86 from the content provider 32 (and thereby receives another manifest which references the secondary content item 86) or the client rendering device determines the location of the chunks based on an algorithm. The client rendering device includes a suitable player to perform the rendering of the content items.

It is appreciated that software components of the present invention may, if desired, be implemented in ROM (read only memory) form. The software components may, generally, be implemented in hardware, if desired, using conventional techniques. It is further appreciated that the software components may be instantiated, for example, as a computer program product; on a tangible medium; or as a signal interpretable by an appropriate computer.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined by the appended claims and equivalents thereof.

1. A system comprising physical computing machinery including:
a chunking processor to:
provide a first content item for consumption by a user, the first content item including a plurality of audio/video frames having a temporal rendering order, the first content item having a content placement opportunity at which a second content item can be consumed by the user in the middle of the consumption of the first content item; and
divide the first content item into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and/or before a second one of the chunks, the placement opportunity being temporally disposed after a first point where the first chunk is operative to finish being rendered and/or before a second point where the second chunk is operative to start being rendered; and
an audio/video codec to encode the chunks yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item:
encoding the audio/video frames of the one chunk at a first audio/video quality yielding a first encoded chunk including the encoded audio/video frames encoded at the first audio/video quality; and
repeating the encoding of the audio/video frames of the one chunk at a second audio/video quality yielding a second encoded chunk including the encoded audio/video frames encoded at the second audio/video quality.

2. The system according to claim 1, wherein:
the chunking processor is operative to divide the second content item into a plurality of chunks, each of the chunks of the second content item including a plurality of audio/video frames; and
the audio/video codec is operative to encode the chunks of the second content item yielding a plurality of encoded chunks of the second content item, each of the encoded chunks of the second content item including a plurality of encoded audio/video frames, each one of the chunks of the second content item being encoded such that decoding an encoded version of the one chunk of the second content item does not require audio/video frame data from any other of the encoded chunks.

3. The system according to claim 2, wherein the audio/video codec is operative to encode the chunks of the second content item such that, for each one of the chunks of the second content item, the audio/video codec is operative to:
encode the audio/video frames of the one chunk at a third audio/video quality yielding a third encoded chunk including a plurality of encoded audio/video frames encoded at the third audio/video quality; and
repeat the encoding of the audio/video frames of the one chunk at a fourth audio/video quality yielding a fourth encoded chunk including a plurality of encoded audio/video frames encoded at the fourth audio/video quality.

4. The system according to claim 1, wherein the physical computing machinery includes a file processor to create a manifest file referencing the encoded chunks of the first content item including referencing the first encoded chunk and the second encoded chunk for each of the chunks of the first content item.

5. The system according to claim 4, wherein the file processor is operative to include, in the manifest file, a reference referencing the content placement opportunity.

6. The system according to claim 5, wherein the reference to the content placement opportunity includes a link to a content decision system which decides which content item should be selected from a selection of content items for rendering as the second content item at the content placement opportunity.

7. The system according to claim 5, wherein the file processor is operative to include, in the manifest file, metadata for use in deciding which content item should be selected from the selection of content items for rendering as the second content item at the content placement opportunity.

8. The system according to claim 4, wherein the physical computing machinery includes a content selection processor to decide which content item should be selected from a selection of content items for rendering as the second content item at the content placement opportunity.

9. The system according to claim 8, wherein the file processor is operative to remove, from the manifest file, the reference referencing the placement opportunity.

10. The system according to claim 4, wherein the file processor is operative to include, in the manifest file, a plurality of references referencing the second content item.

11. The system according to claim 1, wherein each one of the encoded chunks of the first content item includes a random access point, the audio/video codec being operative to encode the one encoded chunk of the first content item such that a first one of the encoded audio/video frames of the one encoded chunk of the first content item to be decoded is at the random access point.

12. The system according to claim 11, wherein the audio/video codec is operative to encode the first content item into a plurality of groups of pictures so that each of the encoded chunks of the first content item includes some of the groups of pictures.

13. The system according to claim 1, wherein the chunking processor is operative to divide the first content item such that the chunks of the first content item have different durations.

14. The system according to claim 13, wherein the chunking processor is operative to determine the duration of some of the chunks prior to the content placement opportunity so that the first chunk, temporally disposed immediately prior to the content placement opportunity, has a duration greater than a predetermined duration.

15. (canceled)

16. The system according to claim 1, wherein the physical computing machinery includes a content selection processor to decide that no content item should be selected for rendering as the second content item at the content placement opportunity.

17. A system comprising physical computing machinery including:
a receiver to receive a manifest file referencing a first content item, the first content item being for consumption by a user, the first content item including a plurality of audio/video frames having a temporal rendering order, the first content item having a content placement opportunity at which a second content item can be consumed by the user in the middle of the consumption of the first content item, the first content item being divided into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and before a second one of the chunks, the placement opportunity being temporally disposed after a first point where the first chunk is operative to finish being rendered and before a second point where the second chunk is operative to start being rendered, the chunks being encoded yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item: encoding the audio/video frames of the one chunk at a first audio/video quality yielding a first encoded chunk including the encoded audio/video frames encoded at the first audio/video quality; and repeating the encoding of the audio/video frames of the one chunk at a second audio/video quality yielding a second encoded chunk including the encoded audio/video frames encoded at the second audio/video quality, wherein:
the manifest file template references the encoded chunks of the first content item including referencing the first encoded chunk and the second encoded chunk for each of the chunks of the first content item; and
the manifest file template includes a reference referencing the content placement opportunity; and
a content selection processor to decide which content item, if any, should be selected from a selection of content items for rendering as the second content item at the content placement opportunity.

18. The system according to claim 17, wherein the manifest file includes metadata for use in deciding which content item should be selected from the selection of content items for rendering as the second content item at the content placement opportunity.

19. The system according to claim 17, wherein the physical computing machinery includes a file processor to:
remove, from the manifest file, the reference referencing the placement opportunity; and
include, in the manifest file, a plurality of references referencing the second content item.

20. The system according to claim 17, wherein the physical computing machinery includes a player to render the second content item at the content placement opportunity.

21. The system according to claim 17, wherein the first content item is divided into the chunks such that the chunks of the first content item have different durations.

22. The system according to claim 21, wherein the duration of some of the chunks prior to the content placement opportunity is determined so that the first chunk, temporally disposed immediately prior to the content placement opportunity, has a duration greater than a predetermined duration.

23. The system according to claim 17, wherein the second content item is divided into a plurality of chunks, each of the chunks of the second content item including a plurality of audio/video frames, the chunks of the second content item being encoded to yield a plurality of encoded chunks of the second content item, each of the encoded chunks of the second content item including a plurality of encoded audio/video frames, each one of the chunks of the second content item being encoded such that decoding an encoded version of the one chunk of the second content item does not require audio/video frame data from any other of the encoded chunks.

24. (canceled)

25. A method comprising:
providing a first content item for consumption by a user, the first content item including a plurality of audio/video frames having a temporal rendering order, the first content item having a content placement opportunity at which a second content item can be consumed by the user in the middle of the consumption of the first content item;
dividing the first content item into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and before a second one of the chunks, the placement opportunity being temporally disposed after a first point where the first chunk is operative to finish being rendered and before a second point where the second chunk is operative to start being rendered; and
encoding the chunks yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item:
encoding the audio/video frames of the one chunk at a first audio/video quality yielding a first encoded chunk including the encoded audio/video frames encoded at the first audio/video quality; and
repeating the encoding of the audio/video frames of the one chunk at a second audio/video quality yielding a second encoded chunk including the encoded audio/video frames encoded at the second audio/video quality.

26. A method comprising:
receiving a manifest file referencing a first content item, the first content item being for consumption by a user, the first content item including a plurality of audio/video frames having a temporal rendering order, the first content item having a content placement opportunity at which a second content item can be consumed by the user in the middle of the consumption of the first content item, the first content item being divided into a plurality of chunks, each one of the chunks including some of the audio/video frames so that the some audio/video frames of the one chunk are for rendering consecutively in accordance with the temporal rendering order, the placement opportunity being temporally disposed after a first one of the chunks and/or before a second one of the chunks, the placement opportunity being temporally disposed after a first point where the first chunk is operative to finish being rendered and/or before a second point where the second chunk is operative to start being rendered, the chunks being encoded yielding a plurality of encoded chunks, each of the encoded chunks including a plurality of encoded audio/video frames, each one of the chunks being encoded such that decoding an encoded version of the one chunk does not require audio/video frame data from any other of the encoded chunks, wherein the encoding includes performing, for each one of the chunks of the first content item: encoding the audio/video frames of the one chunk at a first audio/video quality yielding a first encoded chunk including the encoded audio/video frames encoded at the first audio/video quality; and repeating the encoding of the audio/video frames of the one chunk at a second audio/video quality yielding a second encoded chunk including the encoded audio/video frames encoded at the second audio/video quality, wherein:
the manifest file template references the encoded chunks of the first content item including referencing the first encoded chunk and the second encoded chunk for each of the chunks of the first content item; and
the manifest file template includes a reference referencing the content placement opportunity; and
deciding which content item, if any, should be selected from a selection of content items for rendering as the second content item at the content placement opportunity.
